(19) United States
(12) Patent Application Publication
(10) Pub. No.: US 2026/0087003 A1
(43) Pub. Date: Mar. 26, 2026

(54) SOFTWARE FOR SEARCHING DIGITAL INFORMATION, A SYSTEM COMPRISING A PLURALITY OF SOFTWARE, AND A USER DEVICE CONNECTED TO THE SYSTEM

(71) Applicant: OXIDE AB, Malmö (SE)

(72) Inventors: Lars Hård, Lund (SE); Axel Stålhand, Malmö (SE)

(73) Assignee: OXIDE AB, (US)

(21) Appl. No.: 19/106,383

(22) PCT Filed: Aug. 7, 2023
(86) PCT No.: PCT/SE2023/000009

§ 371 Date: Feb. 25, 2025

(30) Foreign Application Priority Data
Aug. 31, 2022 (SE) 2230274-9

(51) Int. Cl. G06F 16/245; G06F 16/25

(52) U.S. Cl. CPC G06F 16/245; G06F 16/258

(57) ABSTRACT

The present invention relates to searching in digital information. In particular, the present invention relates to a software for searching in digital information, a system 200 comprising a plurality of such software, and a user device 100 connected to such system. An object of the present invention is to provide such a software, system 200 and user device 100 that can take advantage of existing horizontal search engines, vertical search engines and other data sources, to achieve a flexible and powerful search engine.

### TECHNICAL FIELD

The present invention relates to searching in digital information. In particular, the present invention relates to a software for searching in digital information, a system comprising a plurality of such software, and a user device connected to such system.

### BACKGROUND

The search industry is the industry of knowledge and data gathering systems which sorts and ranks information and present relevant information to the user. The device/technology used is called a search engine. The need for the services of a search engine in society is endless and is growing each year. The number of searches made on Google is around 100 000 per second worldwide. Google and other similar standard web search engines (referred to as horizontal search engines) have indexed around 3-4% of the content of the entire internet. This is called the surface web. It's the opposite to the deep web, the part of the web not being indexed by these search engines. A problem with standard web search engines is that they cover only a fraction of the web. A further problem is that results reflect the most popular web pages and ranking is likely biased towards displaying ad-related content. Yet a further problem is that the size of the index has to grow exponentially to represent the web as it expands. At the filing date of this disclosure, the Google index is well over 100,000,000 gigabytes in size.

One important limiting factor for general search is imposed by having a single ranking model, which may be built from multiple algorithms, to decide how the results are produced for every search request. Given this limitation, the results only provide broad generalizations based on popularity, often based on a few typed keywords. For search queries requiring more careful selection of data sources or specific models to sort out what is relevant within a context, single ranking models often fail.

To find information in the deep web, specialized search engines (referred to as vertical search engines) are needed. A vertical search engine is a search engine that is dedicated to a particular subject area. A problem with vertical search is that a user needs to keep track of many different search engines to find a broad variety of content using specialized search engines. Typically, big well-known brands like YouTube, Amazon and Airbnb are top of mind of the user without necessarily providing the best search for a certain topic.

Finally, by having all search requests being processed by the provider of a search engine, the opportunity for privacy invading practices is present when connecting what users search for with how they responded to the alternatives presented. The “tracking” practices by many large search engines has come into light in the public debate and legislative work surrounding privacy.

There is thus a need for improvements within this context.

### SUMMARY OF THE INVENTION

In view of the above, it is thus an object of the present invention to overcome or at least mitigate the problems discussed above. In particular, it is an objective to provide a software, a system and a user device that can take advantage of existing horizontal search engines vertical search engines and other data sources, to achieve a flexible and powerful search engine.

According to a first aspect of the inventive concept, the above objective is achieved by a software for searching digital information, the software having access to external functionality for searching for digital information in each of one or more external data repositories, the software comprising:
a search function comprising:
   a data retrieving function defining the use of the external functionality for searching, wherein running the data retrieving function will retrieve data from the external functionality for searching;
   a data transforming function defining an output format of data retrieved from the external functionality for searching, wherein running the data transformation function will transform said data retrieved from the external functionality for searching according to the output format and expose the transformed data.
an identification declaration suitable for assessing fitness between a search query and the identification declaration.

As used herein, by “software” is generally meant a set of instructions, data and/or programs that can be used to operate computers and execute specific tasks. Software refers to applications, scripts and programs that run on a device. The software can be defined in any programming language and run on any suitable hardware. In the present disclosure, the software is configured to search for, and process, digital information.

As used herein, by “function” is generally meant modules of code that accomplish a specific task. Functions sometimes “take in” (input) data, process it, and “return” (expose) a result. Functions can be “called” (run) from the inside of other functions. Some functions can be called from outside the software, typically via an API. “Running” a function may also be referred to as “executing” or “invoking” the function.

As used herein, by “external functional of searching” is generally meant one or more currently existing services for querying a data repository. Examples of providers of such functionality includes Google, Bing, YouTube, Amazon, price monitoring services, news sites, IEEE, etc.

The inventors have realized that by defining a software that uses external functionality for searching digital information, the strengths of existing search engines can be combined to cover a greater portion or better address specific subjects of the web compared to any single existing search engine. Moreover, the inventors have realized that by defining an identification declaration suitable for assessing fitness between a search query and the identification declaration, the indexing requirement is moved from finding suitable content (web page) based on a search query to finding a suitable software for the search query. The software (e.g., the developers of the software) can (self-)declare what type of search queries that the software is suitable to handle. The identification declaration may consist of running text. Additionally, or alternatively, the identification declaration may consist of declarative code which involves stating the task or desired outcome of the software.

According to some embodiments, the identification declaration comprises at least one from the list of: topical focus, and objective. As an example, topical focus may be to find possible cancer diagnosis based on a set of symptoms, and objective may be to return the most likely diagnosis, in conjunction with evidence (web pages, sections from webpages etc.) thereof. According to some embodiments, the identification declaration is connected to a third-party service or external functionality for accessing or inferring at least parts of the identification declaration. Advantageously, this means that e.g., the topical focus need not be specified to a great extent by the developers of the software. For example, the search functionality may be suitable for determining a resale value for any type of car. In this case, an expand functionality may be used where for example a third-party service is queried for all car brands that exist such that the topical focus described by the identification declaration may include all car brand.

According to some embodiments, the data transforming function defines a ranking of the data retrieved from the external functionality for searching. The ranking can be determined based on any suitable metrics defined in the data transforming function, for example key word count, authority of the sources, similarity or difference between content of the sources, etc.

According to some embodiments, the data transforming function defines a modification of the data retrieved from the external functionality for searching. The modification of the data may be based on a defined (or received) objective for the search function. For example, if the objective is to predict which of a set of companies traded on a specified stock exchange that will perform best tomorrow, the data transforming function may extract suitable metrics from the data retrieved from the external functionality for searching, make statistical calculations on the metrics and return a ranked list of companies based on the statistics.

According to some embodiments, the data transforming function defines a visualization of the data retrieved from the external functionality for searching. The objective of the search function may for example be to plot a map of the highest rated restaurants in a specified town, wherein the data transforming function will create such a map based on the data retrieved from the external functionality for searching.

It should be noted that data transforming function can implement or call any suitable type of AI engine or algorithm to achieve the transformed data through inference. It should also be noted that the data transforming function may define other output formats such as assembling of data from the external functionality for searching digital information in different ways or performing regression analysis on the data received from the external functionality for searching digital information for different reasons and goals.

According to some embodiments, the search function further comprising a data input function configured to receive input data, wherein said input data is used by the data retrieving function when defining the use of the external functionality for searching and/or by the data transforming function when defining the output format of data retrieved from the external functionality for searching. This makes the search functionality of the software more flexible since it can be parameterized and thus configurable based on the search query at hand.

According to some embodiments, the data retrieving function specifically and/or programmatically defines one or more search queries to be used with the external functionality of searching. This means that the search queries used to retrieve data from the external functionality of searching may be pre-defined in the software, increasing the possibility to provide highly specialized search functionality. It may be a very specialized knowledge to define the best search queries for a particular objective, and by providing pre-defined search queries, specifically or via code (e.g., parameterized), this work can be moved from the user to experts. An example of a specifically defined search query is “what is the cheapest dog food in New York”. In the programmatically defined version of the query, “dog” may be replaced by “expand (dog)”, in which the expand function may be implemented by a neural network (or any other generative AI) trained on texts relating to dogs and which returns synonyms of “dog” or words similar to “dog”. The returned words will in the final search query result in a list of words with “OR” in between. Any other programmatical way of defining a search query applies.

According to some embodiments, the input data comprises one or more symbols, wherein the data retrieving function defines the one or more search queries based on the input data. This makes dynamic pre-defined queries possible, increasing flexibility of the search function while still taking advantage of expert definition of queries. Using the above example, the search query may look like this: “what is the cheapest”+expand (dog)+food in [place] where place is defined in the input data.

According to a second aspect of the invention, the above object is achieved by a system comprising a plurality of software of the first aspect, the system comprising:
a query receiving component configured for receiving a search query from a user device;
a query decomposition component configured for decomposing the search query;
a feature extracting component configured for extracting a query feature vector from the search query and/or from the decomposed query and for extracting a software feature vector from the identification declaration of each of the plurality of software;
a mapping component configured for, based on the query feature vector and the plurality of software feature vectors, determining an optimal matched software for the search query;
a transmitting component configured for transmitting the optimal matched software to the user device.

As used herein, by “search query” is generally meant any data suitable to extract features from to perform a search for information. The search query can comprise a text string such as “best sushi in Stockholm” or “Is vitamin D efficient against Covid-19”. The search query can further comprise an image or video, wherein the feature extracting component may be adapted to label or otherwise analyze the input for information. The search query may comprise code such as any type of query language.

As used herein, by “query decomposition” is generally meant to transform a high-level query, for example natural language, into a suitable form for different algorithms to process. In this context, the typical stages of query decomposition are analysis, classification, natura language processing including vector space embedding, normalization and mapping to other representations. The term further includes semantic analysis of the query to define intent, objective, subjects, desired output format, embedding, etc., of the received search query.

As used herein, by “extracting features” is meant finding characteristics in the data that supports separation of possible results from each other. The extraction can be performed using any feature extracting technique, including Machine Learning techniques. For example, for a string of symbols/terms, techniques such as vector embedding, bag-of-words and term frequency can be used.

As used herein, by “mapping” to find the “optimal matched” software is generally meant using any suitable optimization technique to find the best matching vectors. The mapping may take further features into account such as user satisfaction of a result from a certain software, average length of a user exploring the result from a certain software, user interaction of the result from a certain software, execution time of a certain software etc. The system may thus be adapted to receive such input/metrics from the user device from which the search query was received. The mapping may be performed using vector databases, deep neural networks and genetic programming, etc. Advantageously, the use of genetic programming will provide both transparency of the selection/mapping process as well as reduce predictability of the selection/mapping process which effectively reduces the possibility of manipulations such as search engine optimization.

The inventors have realized that by providing a system (search engine) that, instead of searching for the most relevant content directly (by indexing all content), searches for the best search functionality based on the received search query. Advantageously, a much more flexible system may be achieved. Instead of indexing and searching among all possible content, the present system “indexes” and searches among all possible search functionality. Such system may thus provide search in a larger portion of the content on internet compared to any existing horizontal or vertical search engine, without the need of indexing such content directly, but instead index search functionality and leverage already existing indexing of content.

According to some embodiments, the feature extracting component is further configured for extracting a code feature vector from programmatic code of the search function of each of the plurality of software, wherein the mapping component is configured to, based on the query feature vector, the plurality of software feature vectors and the plurality of code feature vectors, determining the optimal matched software for the search query. This embodiment may provide at least two advantages. Firstly, the separation between different software is greatly increased since also the code of the software is used for extracting features that is input to the optimization process (mapping component). Secondly, it makes it possible to verify and extend the data from the identification declaration. The code, inevitably, specifies the functionality of the software. A less honest (or informed) developer that includes wrong information in the identification declaration (to e.g., broaden or move the applicability of the software to certain search queries) will thus be detected, and the matching properties of the software to the search query at hand may thus be lowered compared to if only the data defined in the identification declaration of the software were used.

According to some embodiments, the system comprises a storing component configured to: run the search function of a specific software among the plurality of software and store the exposed data from the data transforming function of the specific software as stored data corresponding to the specific software in a memory, wherein the transmitting component is further configured to retrieve a stored data corresponding to the transmitted software and transmit the retrieved stored data to the user device. Alternatively, or additionally, the storing component may be configured to receive the exposed data from the data transforming function of the specific software from the user device running the software, and store it as described above. Advantageously, this embodiment may support a real-time experience at the user device since it can directly display a previous run of the search function of the software, before optionally do a re-run of the search function to update the displayed data.

According to some embodiments, the system comprises a storing component configured to: run the data retrieving function of a specific software among the plurality of software and store the data retrieved by the data retrieving function of the specific software as stored data corresponding to the specific software in a memory, wherein the transmitting component is further configured to retrieve a stored data corresponding to the transmitted software and transmit the retrieved stored data to the user device. Alternatively, or additionally, the storing component may be configured to receive the data retrieved by the data retrieving function of the specific software from the user device running the software, and store it as described above. Advantageously, this embodiment may provide a real-time experience at the user device since it can skip the data retrieving step of the software and only run the data transforming function of the software and display the exposed data therefrom, before optionally do a re-run of the entire search function to update the displayed data.

According to some embodiments, the transmitting component is further configured to transmit the decomposed query to the user device. The user device may then advantageously use some data from the decomposed query to configure the software, which in turn makes the software more flexible and able to handle a variety of search queries.

According to some embodiments, the plurality of software is stored in a database, wherein access to the database is exposed externally through an API. Advantageously, this means that any third party can build its own search engine system, leveraging all existing software according to the first aspect. This embodiment overcomes the single source problem where one single provider/implementer, have control over an important functionality such as a search engine and its ranking/selection algorithm for content.

According to some embodiments, the system is configured to determine whether the search query comprises executable code (software), wherein, upon determining that the search query comprises executable code of a predefined type, the system receiving component is configured to transmit the search query to the transmitting component for further transmission to the user device. This embodiment may allow the possibility that if the search query comprises a software according to the first aspect, the search query is directly returned to the user device to be run/executed. In this case, if the software defines the database of software (according to the above) as an external data repository, a flexible and simple way of overcoming the single source problem may be achieved.

According to a third aspect of the invention, the above object is achieved by a user device connected to a system of the second aspect, and having functionality for:
transmit a search query to the receiving component of the system;
receive a software from the transmitting component of the system;
run the search function of the software locally on the user device; and
display the exposed data of the data transforming function the software.

Advantageously, the user of the user device does not have to keep track of all available search engines or other data sources but may instead provide a search query to the device that in turn will display the data received from the most suitable software. The search query may also be loaded into the user device, or triggered automatically from the user device, directly or via an external service.

According to some embodiments, the user device having functionality for:
transmit a search query to the receiving component of the system;
receive a software from the transmitting component of the system and a stored data corresponding to received software;
display the stored data;
run the search function of the software locally on the user device; and
display the exposed data of the data transforming function the software and hide the displayed stored data.

Advantageously, a real-time experience may be achieved for queries leveraging a software requiring significant resources or requests to external data sources. Moreover, this embodiment may lower the processing requirements of the user device since it is not equally important to quickly execute the search function of the software.

According to some embodiments, the user device having functionality for:
transmit a search query to the receiving component of the system;
receive a software from the transmitting component of the system and a stored data corresponding to received software;
provide the stored data to the data transforming function of the software to modify the stored data and display the exposed data of the data transforming function of the software.

Advantageously, the user device can take advantage of previous runs of configurable software. For example, if a software is adapted to extract data relating to cancer diagnosis, and then depending on the configuration (through the data input function) of the software, return differently modified data, the user device providing a first configuration may take advantage of data resulting from a user device providing a second different configuration.

According to some embodiments, the device may be further configured to
after providing the stored data to the data transforming function of the software, run the search function the software locally on the user device, run the search function the software locally on the user device; and
display the exposed data of the data transforming function of the software and hide the previously displayed stored data.

Consequently, a data from a fresh run of the search function of the software is shown by the user device, thus showing a recently updated data.

According to some embodiments, the user device having functionality to:
transmit a search query to the receiving component of the system;
receive a software and a decomposed search query from the transmitting component of the system;
transmitting at least parts of the decomposed search query to the data input function of the software;
run the search function the software locally on the user device; and
display the exposed data of the data transforming function the software.

This embodiment advantageously provides the possibility of configuring the software according to specifics of the search query.

The second and third aspects may generally have the same features and advantages as the first aspect. It is further noted that the invention relates to all possible combinations of features unless explicitly stated otherwise.

### BRIEF DESCRIPTION OF THE DRAWINGS

The above, as well as additional objects, features and advantages of the present invention, will be better understood through the following illustrative and non-limiting detailed description of embodiments of the present invention, with reference to the appended drawings, where the same reference numerals will be used for similar elements wherein:

FIG. 1 shows by way of example a system and a user device,

FIG. 2 shows by way of example a software and a user device

FIG. 3 shows by way of example a feedback process between a user device and a system,

FIG. 4 shows a data storing process according to some embodiments.

### DETAILED DESCRIPTION

The present invention will now be described more fully hereinafter with reference to the accompanying drawings, in which embodiments of the invention are shown. The systems, software and devices disclosed herein will be described during operation.

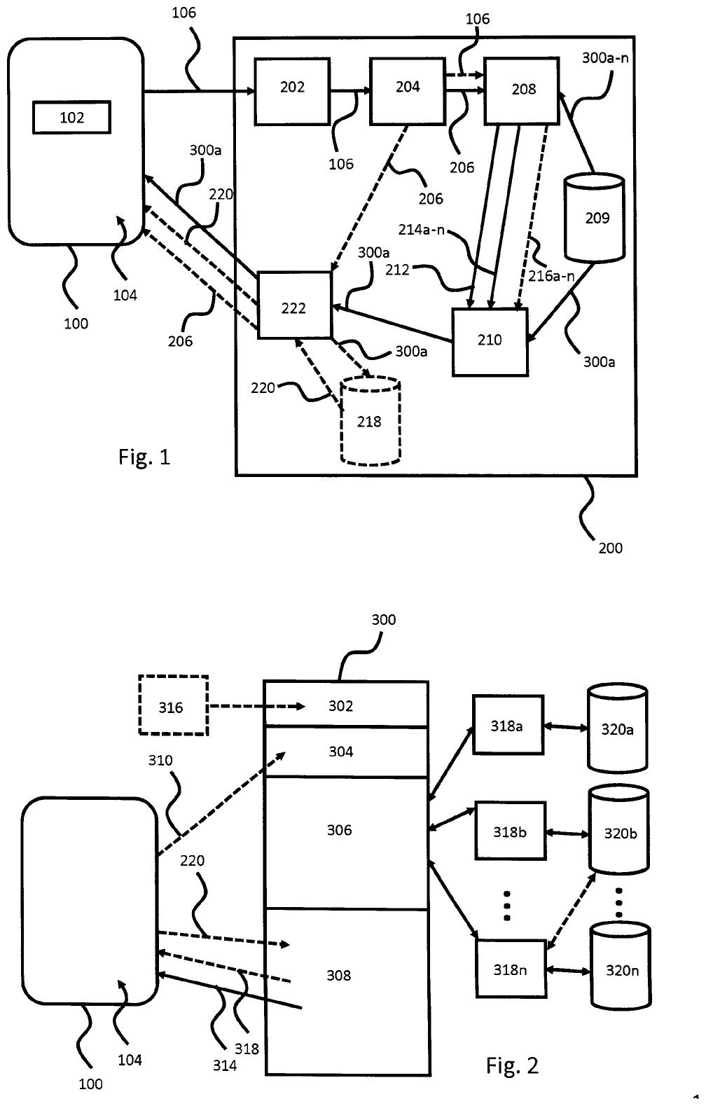

FIG. 1 shows by way of example functionality off, and interaction between, a system 200 and a user device 100. In FIG. 1, a search query 106 is transmitted from the user device 100 to the system, triggered by a search query input 102 from a user of the user device 100. However, this use case is only for ease of explanation. In other embodiments, the search query 106 is loaded into the user device 100, or triggered from the user device 100. The triggering can be based on a time period that has expired, or can be triggered from an external source, for example the system 200 as will be further exemplified below.

In the embodiment of FIG. 1, the user device 100 comprises means for receiving a search query input 102 from a user. The search query input 102 can be input using any suitable means, for example a keyboard. The keyboard can be a virtual keyboard, for example displayed on a display 104 of the user device 100, or a physical keyboard connected to the user device 100. Any other means for providing input may be used, for example the user device 100 may have a speech recognition component which can interpret speech recorder through a microphone of the user device.

The user device 100 is connected, wireless or wired, to a system 200. The system may be implemented on one or several servers. The servers may be dedicated (bare metal) servers to run the system 200, or be implemented in a cloud solutions such as AWS. The search query input results in a search query 106 being transmitted from the user device 100 to the system 200. The system 200 thus have a query receiving component 202 configured for receiving the search query 106 from the user device 100. The search query 106 is typically defined by a string/collection of symbols transmitted to the server. In some embodiments, the search query comprises running text, or a set of keywords. In other embodiments, the search query comprises programmatic code. The search query could be defined by a parametric search input (also known as faceted search).

The search query is then decomposed by a query decomposition component 204.

Details of the query decomposition depends on how the query will be executed downstream, what types of databases that the query will be searching in, the format of data stored in the databases, etc. It should be noted that the query decomposition component 204 may use a processor of the system 200 for the decomposition. In other embodiments (not shown in FIG. 1), the query decomposition component 204 may use an external processor to decompose the query, for example by requesting the user device 100 to perform the query decomposition and to return the decomposed query to the query decomposition component 206.

The decomposed query 206 is then transmitted to a feature extracting component 208. Optionally, the search query 106 is also transmitted to the feature extracting component 208. Feature extraction is a process of dimensionality reduction by which an initial set of raw data (e.g., the decomposed query 206) is reduced for processing. Feature extraction is the name for methods that select and/or combine variables into features, effectively reducing the amount of data that must be processed, while still accurately and completely describing the original data set. The feature extracting component extracts a feature vector 212, herein referred to as a query feature vector, from the decomposed query 206 and/or from the search query 106.

The feature extracting component 208 is further connected to a database 209 in which software's 300a-n are stored. The database 209 can be any type of data storage component or in-memory representation. In the example of FIG. 1, the database 209 is part of the system 200, but it is equally possible that the database 209 is external to the system 200. In some embodiments, access to the database 209 is exposed externally through an API.

A software 300 will now be briefly described. A more detailed description is found below in conjunction with FIG. 2. The software 300 is configured for searching digital information. The software 300 can be referred to as a virtual search engine, albeit typically within a specific topic and with a specific objective. The software comprises a function (ref 306 and 308 in FIG. 2) for searching data and exposing said data (referred to herein as a search function), and a data/algorithm (referred to herein as an identification declaration, ref 302 in FIG. 2) suitable for assessing fitness between a search query and the identification declaration.

The feature extracting component 208 is further configured for extracting a feature vector (referred to herein as a software feature vector 214) from the identification declaration 302 of each of the plurality of software 300a-n.

According to some embodiments, the feature extracting component 208 is further configured for extracting a feature vector (referred to herein as a code feature vector 216) from programmatic code of the search function 306, 308 of each of the plurality of software 300a-n.

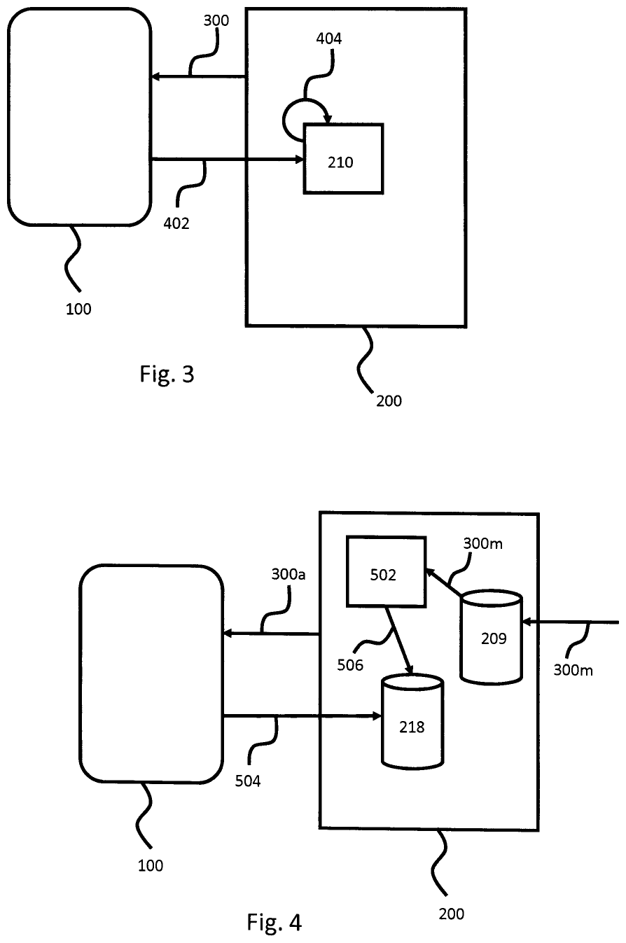

The query feature vector 212, the plurality of software feature vectors 214a-n and optionally the plurality of code feature vectors 216a-n are then transferred to a mapping component 210. The mapping component 210 are configure do determine an optimal matched software 300a for the search query 106. Selection of the most suitable software to handle a particular search query has thus turned into an optimization problem. In its simplest form, the optimization tries to find the most common features between a identification declaration of a software 300 and the search query 106, e.g, a string-matching optimization problem. According to other embodiments, data such as objective, entities and such extracted from the search query 106 are compared to the similar data in the identification declaration. In even other embodiments, also the code of the search function of the software 300 is analyzed to extract features relating to its actual function, which also are input to the optimization problem. In yet other embodiments, feedback from the user exploring the search result from a particular software is also included in the optimization problem, as will be described more in detail below in conjunction with FIG. 3.

One problem with current search engines may be that the ranking algorithm is hidden from the user (black box ranking). This gives the provider of the search engine the possibility to provide search result which are not only focused on quality and accuracy of the ranked list, but also considering factors that will drive the business model of the provider of the search engine. Moreover, such algorithms typically can be exploited by search engine optimization (SEO) expert, that will tweak the content to get higher on the ranking. SEO typically lower the quality of the content since the additions is not made to improve the quality, accuracy or details of the content based on the topic of the content, but instead only added to improve ranking. With the system suggested in this disclosure, such problem may be avoided. The mapping component 210 may for example be the result of a genetic programming algorithm that evolves the algorithm to find the best matched software. Such a generated program to perform the mapping is fully transparent, and the ranking/selection algorithm, in form of code, can be directly investigated and verified. Moreover, the evolutionary approach of the genetic programming algorithm inherently means that the mapping process will continuously evolve and effectively remove or at least reduce the problem of SEO since the actual ranking becomes a moving target

It should be noted that the algorithm used by the mapping component may be any suitable type of mapping algorithm such as approximate nearest neighbor or a neural network optimized by a stochastic gradient decent algorithm. For some mapping algorithms, different features in the feature vectors may have different weights associated to them, wherein the weights may be hard coded or in themselves optimized (for example using a genetic algorithm).

It should be noted that the disclosure may elevate the black box ranking algorithm problem in more than one way. According to some embodiments, not shown in FIG. 1, the system 200, for example the receiving component 202, is configured to determine whether the search query 106 comprises executable code. This is allowed, and for some types of code, the normal processing flow described below will apply. However, upon determining that the search query 106 comprises executable code of a predefined type, the system 200 receiving component is configured to transmit the search query to a transmitting component 222 for further transmission back to the user device 100. This embodiment may provide a flexible and simple way of overcoming a single source problem as well as the black box ranking problem. In case the search query comprises a software as described herein, and this software defines the database 209 of software 300a-n (according to the above) as an external data repository, the software included in the search query may effectively implement a selection or ranking process of a best match software 300 among the software 300a-n similar to the one described in FIG. 1. Essentially, the user device 100 may thus implement parts of or the entire system.

Returning now to FIG. 1, the mapping component 210 will thus determine an optimal matched software 300a from the plurality of available software's 300a-n. The optimal software is then, wired or wirelessly, transmitted from a transmitting component 222 to the user device for execution as will be described below in conjunction with FIG. 2. In some embodiments, the system 200 may transmit the software 300a in the form of a web browser page (answer page) configured to run the software 300a when loaded by the user device 100. When the answer page is loaded at the user device 100, an interpreter of the language of the software 300a may be loaded via e.g., JavaScript, along with any other necessary packages of auxiliary software packages that are needed to run the functions of the software 300a. In other embodiments, the interpreter and/or the auxiliary software packages may already be loaded in e.g., the web browser or application from which the user device provides the search query 106 to the system 200 at the time when the user provides the search query 106 to the device 100.

In some embodiments, the system comprises a storing component 218 that store data relating to previous runs of the software's 300a-n. How, which parts of, and when the data is stored will be described below in conjunction with FIG. 4. In some embodiments, the transmitting component 222 is further configured to retrieve a stored data 220 corresponding to the transmitted software 300 and transmit the retrieved stored data 220 to the user device.

In some embodiments, the transmitting component 222 is further configured to transmit the decomposed query 206 to the user device 100. In some embodiments, the query decomposition component 204 is configured to transmit the decomposed query 206 to the transmitting component 222. The user device 100 will thus receive the optimal matched software 300a from the transmitting component 222 of the system 200. The software, or the search function thereof will be run locally on the user device as will be described below in conjunction with FIG. 2. Finally, the data exposed by the software 300a, which thus is the answer to the initial search query 106, will be displayed 104.

According to some embodiments not shown in FIG. 1, the user device may modify the received software 300a, e.g., based on user requirements or user behavior when interacting with the data exposed by the software. The modified software may then be transmitted back to the system 200 as a new software for storage in the database 209.

According to some embodiments not shown in FIG. 1, and mentioned above, the user device 100 may be triggered to provide a search query 106 by the system 200. For example, the user device 100 may subscribe to a certain software, or a certain search query. The system 200 may continuously run the subscribed software, or the subscribed search query to find out when data exposed by the software or resulting from the search query have changed more than a threshold since last time it was run. If this happens, the system 200 may trigger the user device 100 to provide the search query 106 to which it subscribes.

FIG. 2 describes functionality off, and interactions between, a user device 100 and a software 300. The software 300 is, as described above, configured for searching digital information. As shown in FIG. 2, the software 300 has access to external functionality 318a-n, for searching digital information in each of one or more external data repositories 320a-n. Each functionality 318a-n thus is in wired or wireless communication with one or more data repositories 320a-n. The functionality 318 may be implemented in a dedicated server or in the cloud. Each functionality 318 is accessible, e.g., via an API. Examples of such functionalities are existing horizontal search engines such as Bing, Yahoo, Duck Duck Go, and existing vertical search engines such as Youtube, Amazon, Alibaba, any news site, research paper search engine, etc. As described above, also the database 209 of software 300a-n may be regarded as such a data repository. All custom-made collections of data, which is searchable and accessible externally via e.g. an API may thus be used as external functionality 318a-n. For avoidance of a doubt, password protected search engines may of course also be used, wherein the password for access must be input to, or hardcoded in, the software 300.

The software 300 may comprise a data input function 304 configured to receive input data 310 from the user device 100. For example, input data 310 may include password and username for password protected external search functionality 318a-n. Other types of input data will be detailed below.

The software comprises a search function which in turn comprises a data retrieving function 306 and a data transforming function 308. The search function can be run from outside the software 300, and in some embodiments the data retrieving function 306 and/or the data transforming function 308 may also be separately run from outside the software 300.

The data retrieving function 306 defines the use of the external functionality 318a-n for searching. For example, the data retrieving function 306 may define different search queries to be used for different external functionality 318a-n.

Some external functionality 318a-n may be called using a plurality of different search queries. According to some embodiments, data 310 inputted by e.g., the user of the user device 100, via the data input function 304 of the software 300 is used in data retrieving function 306 when defining the use of the external functionality for searching. For example, the input data 310 may define parameters to be used in the search queries. The input data may for example define geographic focus of the search, or details of a search like the color of a goods that is searched for. The input data may define any type of filter parameters, specifications, details, preferred weighting, etc., to be used by the external functionality 318a-n for searching. By this feature, the data acquisition performed by the software 300 may be configured and steered according to the requirements of a user of the user device 100. The input data may be stored on the local device for repeated use. Since it will only be available from the user device 100, it cannot be tracked by an outside party (e.g., the system 200), whereby a level of privacy protection may be achieved.

The software 300 further comprises a data transforming function 308. The data transforming function 308 is configured to transform data from the external functionality 318a-n for searching according to an output format which is defined in the data transforming function 308. Data retrieved by the external functionality 318a-n for searching is formatted and structured according to the functionality of these external search engines, and according to the data format of the external data repositories 320a-n connected thereto. However, topical focus and objective of the search function may require certain aggregation of data. Furthermore, mapping from the space of the retrieved data to another space may be required. For example, the objective of the search function may be a prediction of a stock exchange. The data transforming function 306 may comprise, or have access to, an AI engine configured to make such prediction, also known as AI interference. In this context it should be noted that the software 300 may have access to, or implement, any type of modules or packages for statistic calculations, math, Machine Learning, Artificial intelligence, visualization, text analysis, external requests to other API's, etc. In some embodiments, the software 300 is run in a JavaScript environment on the user device 100 which provides access to all types of required external functionality/libraries needed in the data transforming function 308.

The data transforming function 308 may thus define a ranking of the data retrieved from the external functionality 318a-n for searching. Alternatively, or additionally, the data transforming function 306 may define a modification of the data retrieved from the external functionality for searching. Alternatively, or additionally, the data transforming function 306 may define a visualization of the data retrieved from the external functionality for searching.

The data transforming function 308 may take input data 310 received by the data input function 304, and use (part of) this data when defining the output format of data retrieved from the external functionality for searching. By this feature, the data transformation performed by the software 300 may be configured and steered according to the requirements of a user of the user device 100. Similar to described above, the input data may be stored on the local device for repeated use. Since it will only be available from the user device 100, it cannot be tracked by an outside party (e.g., the system 200), whereby a level of privacy protection may be achieved

When being run, the data transforming function 308 will transform data retrieved from the external functionality 318a-n for searching according to the output format and expose 314 the transformed data. In some embodiments, the data transforming function 308 receives the data which it transforms from the data retrieving function 306. In other embodiments, further described below, the data transforming function 308 receives data to transform from the user device 100.

According to some embodiments, the actual code of the search function, i.e., the data transforming function 308 and the data retrieving function 306 may be accessible from the outside. This makes analysis of the functionality of the software 300 possible, which can be used when finding the optimal matched software among a plurality of software's for a particular search query or search mission, as described above.

The software further comprises an identification declaration 302. This data/algorithm is suitable for assessing fitness between any search query and itself. The purpose of identification declaration is to let the author of the software (e.g., a developer or an AI system) define for which search queries the software 300 is suitable to use. The identification declaration 302 may thus be seen as a self-declaration of things like functionality and objective of the software 300.

The identification declaration 302 may include everything from a simple text description of a suitable use of the software, such as “Finds the best priced televisions in the US” to complex programmatic definitions of e.g., output format (scalar, vector, symbol, Boolean, graph, etc.,) and objectives (recall, decision, bridge, prove, etc.,). The identification declaration 302 may define sources in the search (PubMed, New York Times, etc.,). In some embodiments, the identification declaration 302 defines at least one from the list of: topical focus, and objective. The identification declaration 302 may be connected to third party services 316 (or any other external functionality) for accessing or inferring some of its data. For example, the identification declaration 302 may comprise functionality for expanding certain expressions such as cancer (Multiple Myeloma, Sarcoma, Leukemia, etc.) to be able to define fitness to search queries including all types of cancer diagnoses. The data of the identification declaration 302 may comprise suitable search queries for the software (“Is cancer caused by vitamin c”, “Is vitamin c causing cancer”, etc.,)

As shown in FIG. 1 and described above, the user device 100 will receive an optimally matched software 300 from the system 200, based on the search query 106 that the user of the user device 100 provided. The user device 100 may further receive the decomposed version 206 of the search query 106 from the system 200. In some embodiment (not shown in FIG. 1, and further described above) the user device may already have access to the decomposed version 206 of the search query since the query decomposition component 204 of the system requested the user device 100 to perform the decomposition.

Parts of the decomposed query 206 may be provided as input data 310 to the software 300 as described above. The user device 100 may provide further input data 310 if needed. For example, input data 310 may comprise data relating to processing power or hardware of the user device. In some embodiments, the software 300 may define different functionality targeted to different types of user devices 100, for example defining less complex visualizations for a smart phone compared to if the user device 100 is a virtual reality device.

When the user device 100 receives the optimal matched software 300, it executes or runs it using one or more processors of the user device 100. As exemplified above, the software 300 may be run in a JavaScript in a web browser, but any suitable computer language (C, C++, etc.,) may be used in the browser sandbox environment via WebAssembly. The software 300 may require certain software packages to be installed at the user device, or the software 300 may itself load these software packages when being run. When the software 300 is received, it is run locally on the user device 100. The exposed data 314 from the data transforming function 308 of the software 300 is displayed by a display 104 of the user device.

Running the search function 306, 308 of the software 300 may take some time, in particular if there is a lot of data to be acquired, and much transformation needs to be performed. For this reason (to facilitate near real time display of data), the user device 100 may, as described above, receive a stored data 220 corresponding to the software 300 from the system 200. The stored data 220 may represent data already being transformed by the data transforming function 308. In that case, the user device may be configured to directly display 104 the stored data 220 before optionally running the search function 306, 308 of the software 300 locally on the user device 100. When the data is exposed by the data transforming function 308 the software 300, then the user device may be configured to display the exposed data 314 of the data transforming function 308 the software and hide the displayed stored data 220. In other embodiments, the stored data 220 received from the system 200 represent the data retrieved from the external functionality for searching. In that case, data transformation needs to be applied to the stored data 220 to fulfill the requirements of the search query 106. For that reason, the user device 100 may be configured to provide the stored data 220 to the data transforming function 308 of the software. The software 300 will then modify the stored data 220 and expose the thus modified data 318 of the data transforming function 308 of the software. The user device 100 may then be configured to run the full search function 306, 308 of the software 300 and display the exposed data 314 of the data transforming function 308 the software 100 and hide the displayed stored data 318.

FIG. 3 schematically shows a feedback process between the user device 100 and the system 200. According to some embodiments, the user device 100 may, upon receiving a software 300, provide feedback 402 regarding the result from the software 300 to the system 200, and in particular to the mapping component 210 of the system 200. The feedback may be defined in any way. One feedback may relate to user satisfaction of the received result and how well it mapped to the provided search query. Such feedback may comprise one or more grades between 1-10 or similar. Other feedback may be automatically calculated, for example based on the interactions between the user and the data from the software 300. Such feedback may comprise for how long the user browsed around in the data, how many links the user clicked on in the data, how much the user changed the search query for a next search, etc. Feedback may further relate to the processing power required to run the software 300 on the user device, or the amount of data received and transmitted by the user device 100 when running the search function of the software 300.

According to some embodiments, a user device 100 may subscribe to a certain search query and receive new data, or get notified if new data exist, for that search query. Such a subscription model may be coordinated by the system 200 which continuously run search queries that are subscribed to and compare the output data of the optimal matched software 300 for that search query with a previous run for the same search query. If the data have changed or is considered more accurate/truthful by the system, the user devices 100 that subscribe to that search query may receive a push notice or new data directly. In this case, a user device keeping its subscription after receiving new data may be considered as positive feedback for the software 300 that provided that new data. Similarly, a user device aborting its subscription may be considered as negative feedback.

Any or all feedback received by the mapping component 210 may be used to improve the optimization process 404 to determine the optimal matched software 300 for a particular search query. For example, a low user satisfaction may reduce the applicability of a particular software 300a-n for a particular search query 106. Similar, a frequent high user interaction may be considered as positive feedback. Features may be extracted from the feedback which then are included in the optimization process 404, complementary to the query feature vector 212, the plurality of software feature vectors 214a-n and optionally the plurality of code feature vectors 216a-n as discussed in conjunction with FIG. 1 above.

FIG. 4 shows by way of example a data storing process. As described above, data originating from a run of a software 300 may be stored for several reasons. One reason is to provide a robust near real-time experience for the user. Another reason is to know when user devices that subscribes to a search query should receive new data, or a push that new data is available. Yet another reason is that stored data can be heavily compressed and thus reduce the data throughput at a user device in case it can reduce the need of data acquisition from the external functionality for searching as described above. In some embodiments, each time, or sometimes, when a user device receives a software 300a, the user device 100 may subsequently provide the system 200 with data 504 exposed by the software 300a, such as for example the data from the external functionality for searching (via the data retrieving function of the software 300a) or the transformed data from the data transforming function of the software 300a. The thus provided data 504 may include a pointer or index of the software from which the data 504 originated and will be stored in the storing component 218.

In other embodiments, each time a new software 300m is received by the system and stored in the database 209 of available software's, the software is also run (via a component 502), whereby data 506 exposed by the new software 300m (by the data retrieving function and/or the data transforming function thereof) is stored together with a pointer to the new software 300m in the storing component 218.

In yet other embodiments, each software stored in the database 209 is continuously run by the component 502 whereby data 506 exposed by the each of the software (by the data retrieving function and/or the data transforming function thereof) is stored together with a pointer to the corresponding software in the storing component 218. Different software 300 may be run with different time intervals. More popular software 300 (which are retrieved often by user devices 100) may for example be run more often by the component 502. Another example is that an analysis of output data from a particular software 300 from different run may reveal that data from that particular software changes more than a threshold between runs, which will inform the component 502 that this particular software should be run more often to keep an updated data in the storing component 218.

Data stored in the storing component 218 may be heavily compressed to for example remove images, movies, sound etc. Consequently, small sized data may comprise much information.

The systems and functionality disclosed hereinabove may be implemented as software, firmware, hardware or a combination thereof. In a hardware implementation, the division of tasks between functional units referred to in the above description does not necessarily correspond to the division into physical units; to the contrary, one physical component may have multiple functionalities, and one task may be carried out by several physical components in cooperation. Certain components or all components may be implemented as software executed by a digital signal processor or microprocessor or be implemented as hardware or as an application-specific integrated circuit. Software and functions thereof may likewise be executed by a digital signal processor or microprocessor or be implemented as hardware or as an application-specific integrated circuit. Software may be distributed on computer readable media, which may comprise computer storage media (or non-transitory media) and communication media (or transitory media).

1. A software for searching and processing digital information, the software having access to external functionality for searching for digital information in each of one or more external data repositories, the software comprising:
a search function comprising:
a data retrieving function defining the use of the external functionality for searching, wherein running the data retrieving function will retrieve data from the external functionality for searching;
a data transforming function defining an output format of data retrieved from the external functionality for searching, wherein running the data transformation function will transform said data according to the output format and expose the transformed data;
an identification declaration suitable for assessing fitness between a search query and the identification declaration.

2. The software of claim 1, wherein the identification declaration comprises at least one from the list of: topical focus, and objective.

3. The software of claim 2, wherein the identification declaration is connected to a third-party service or external functionality for accessing or inferring at least parts of the identification declaration.

4. The software of claim 1, wherein the data transforming function defines a ranking of the data retrieved from the external functionality for searching.

5. The software of claim 1, wherein the data transforming function defines a modification of the data retrieved from the external functionality for searching.

6. The software of claim 1, wherein data transforming function defines a visualization of the data retrieved from the external functionality for searching.

7. The software of claim 1, wherein the search function further comprising a data input function configured to receive input data, wherein said input data is used by the data retrieving function when defining the use of the external functionality for searching and/or by the data transforming function when defining the output format of data retrieved from the external functionality for searching.

8. The software of claim 1, wherein the data retrieving function specifically and/or programmatically defines one or more search queries to be used with the external functionality of searching.

9. The software of claim 8, wherein the search function further comprises a data input function configured to receive input data, wherein said input data is used by the data retrieving function when defining the use of the external functionality for searching and/or by the data transforming function when defining the output format of data retrieved from the external functionality for searching, and
wherein the input data comprises one or more symbols, wherein the data retrieving function defines the one or more search queries based on the input data.

10. A system comprising a plurality of software of claim 1, the system comprising:
a query receiving component configured for receiving a search query from a user device;
a query decomposition component configured for decomposing the search query;
a feature extracting component configured for extracting a query feature vector from the search query and/or the decomposed query and for extracting a software feature vector from the identification declaration of each of the plurality of software;
a mapping component configured for, based on the query feature vector and the plurality of software feature vectors, determining an optimal matched software for the search query;
a transmitting component configured for transmitting the optimal matched software to the user device.

11. The system of claim 10, wherein the feature extracting component is further configured for extracting a code feature vector from programmatic code of the search function of each of the plurality of software, wherein the mapping component is configured to, based on the query feature vector, the plurality of software feature vectors and the plurality of code feature vectors, determining the optimal matched software for the search query.

12. The system of claim 10, further comprising a storing component configured to:
run the search function of a specific software among the plurality of software and store the exposed data from the data transforming function of the specific software as stored data corresponding to the specific software in a memory,
wherein the transmitting component is further configured to retrieve a stored data corresponding to the transmitted software and transmit the retrieved stored data to the user device.

13. The system of claim 10, further comprising a storing component configured to:
run the data retrieving function of a specific software among the plurality of software and store the data retrieved by the data retrieving function of the specific software as stored data corresponding to the specific software in a memory,
wherein the transmitting component is further configured to retrieve a stored data corresponding to the transmitted software and transmit the retrieved stored data to the user device.

14. The system of claim 10, wherein the transmitting component is further configured to transmit the decomposed query to the user device.

15. The system of claim 10, wherein the plurality of software is stored in a database, wherein access to the database is exposed externally through an API.

16. The system of claim 10, wherein the system is configured to determine whether the search query comprises executable code, wherein, upon determining that the search query comprises executable code of a predefined type, the system receiving component is configured to transmit the search query to the transmitting component for further transmission to the user device.

17. A user device connected to a system comprising a plurality of software of claim 1, the system comprising:
a query receiving component configured for receiving a search query from a user device;
a query decomposition component configured for decomposing the search query;
a feature extracting component configured for extracting a query feature vector from the search query and/or the decomposed query and for extracting a software feature vector from the identification declaration of each of the plurality of software;
a mapping component configured for, based on the query feature vector and the plurality of software feature vectors, determining an optimal matched software for the search query;
a transmitting component configured for transmitting the optimal matched software to the user device,
the user device of having functionality to:
transmit a search query to the receiving component of the system;
receive a software from the transmitting component of the system;
run the search function the software locally on the user device; and
display the exposed data of the data transforming function the software.

18. The user device of claim 17, wherein the system comprises a storing component configured to: run the search function of a specific software among the plurality of software and store the exposed data from the data transforming function of the specific software as stored data corresponding to the specific software in a memory, wherein the transmitting component is further configured to retrieve a stored data corresponding to the transmitted software and transmit the retrieved stored data to the user device, and wherein the user device further has functionality to:
receive a stored data corresponding to received software;
display the stored data; and
hide the displaced stored data.

19. The user device of claim 17, wherein the system comprises a storing component configured to: run the data retrieving function of a specific software among the plurality of software and store the data retrieved by the data retrieving function of the specific software as stored data corresponding to the specific software in a memory, wherein the transmitting component is further configured to retrieve a stored data corresponding to the transmitted software and transmit the retrieved stored data to the user device, and wherein the user device further has functionality to:
receive a stored data corresponding to received software;
provide the stored data to the data transforming function of the software to modify the stored data; and
after providing the stored data to the data transforming function of the software,
hide the displayed stored data.

20. (canceled)

21. The user device of claim 17, wherein the transmitting component of the system is further configured to transmit the decomposed query to the user device, wherein the search function of the received software of the user device further comprises a data input function configured to receive input data, wherein said input data is used by the data retrieving function when defining the use of the external functionality for searching and/or by the data transforming function when defining the output format of data retrieved from the external functionality for searching, and, wherein the user device further has functionality to:
receive and a decomposed search query from the transmitting component of the system; and
transmitting at least parts of the decomposed search query to the data input function of the software.
